(19) United States
(12) Patent Application Publication
(10) Pub. No.: US 2017/0121534 A1
(43) Pub. Date: May 4, 2017

(54) USE OF GAMMA IRON(III) OXIDE (GAMMA-FE2O3) CONTAINING PARTICLES FOR THE PREVENTION OF BIOFOULING AND/OR GROWTH OF MICROORGANISMS

(71) Applicant: BASF SE, Ludwigshafen (DE)

(72) Inventors: Rute da Conceicao TAVARES ANDRE, Mainz (DE); Nico Frederik FISCHER, Heidelberg (DE); Patrick HUBACH, Haßloch (DE); Christian WALSDORFF, Ludwigshafen (DE); Christoph SCHWIDETZKY, Haßloch (DE)

(21) Appl. No.: 15/319,142

(22) PCT Filed: Jun. 8, 2015
(86) PCT No.: PCT/EP2015/062660

§ 371 Date: Dec. 15, 2016

(30) Foreign Application Priority Data
Jun. 18, 2014 (EP) 14172945.9

(51) Int. Cl. C09D 5/16; C09D 7/12; A01N 25/02; A01N 59/16; A01N 59/00

(52) U.S. Cl. CPC C09D 5/1618; A01N 59/16; A01N 59/00; A01N 25/02; C09D 7/1275; C09D 7/1266

(57) ABSTRACT

The present invention relates to the use of gamma iron(III) oxide (γ-Fe₂O₃) containing particles for the prevention of biofouling and/or growth of microorganisms. Furthermore, it relates to a method for preventing biofouling of a substrate and to a method of imparting biocidal properties to the surface of a substrate.

The present invention relates to the use of gamma iron(III) oxide (γ-Fe₂O₃) containing particles for the prevention of biofouling and/or growth of microorganisms. Furthermore, it relates to a method for preventing biofouling of a substrate and to a method of imparting biocidal properties to the surface of a substrate.

Marine biofouling is an everlasting and costly problem for the maritime industry. Barnacles, green algae, diatoms, and mussels are notorious for attaching to and damaging man-made structures. The growth of fouling assemblages on ship hulls causes increased drag, reducing maneuverability, increasing fuel consumption and greenhouse gas emissions and thus has both economic and environmental costs.

In closed water systems (water purification, desalination and the like) using e.g. plastic parts such as pipes, filters, valves or tanks, surfaces can be subject to bacterial or algal colonization and biofilm formation, followed by deterioration of the materials and contamination of the circuit liquids. Another problem is the spoilage of water and/or aqueous compositions stored in containers for a prolonged period.

Other problems with said surfaces can derive from algal or bacterial biofilm formation resulting in an undesired change in their hydrodynamic properties and affecting e.g. the flow-rate in pipes, the trouble-free use of boats and other marine or limnological applications.

These problems have so far been addressed mainly by development and application of fouling resistant marine coatings. The relevant surfaces are often coated with paints, e.g. water based paints. Conventional water based paints are often preserved by adding non-enzymatic organic biocides such as thiocyanate, tetracycline, or isothiazolinones to the paint. Water based paints must be preserved to prevent microbial growth enabled by the increased water activity in these paints. Therefore, large amounts of conventional biocides are used for this purpose. This has stimulated the search for environmentally benign alternatives to the conventional biocides.

Antifouling paints based on the cytotoxic effects of metal complexes have been banned because of the deleterious effects of accumulating metals such as copper or tin from polymer coatings thus prompting increased research with regard to sustainable alternatives. Coatings that do not release biocides, such as “fouling-release” silicone elastomers, are considered environmentally benign and therefore more adequate. However, these coatings lack antifouling properties under static conditions, and hydrodynamic shear is needed to release the fouling organisms. Thus, a universally applicable solution for vessels that are either stationary or slow moving and that is effective against a broad range of fouling organisms is needed.

Haloperoxidases have been proposed as antifouling additives (WO 1995/027009). Vanadium haloperoxidases (V-HPOs) are enzymes that catalyze the oxidation of halides to the corresponding hypohalous acids according to H₂O₂+X⁻+H⁺═HOX+H₂O using hydrogen peroxide (H₂O₂) as the oxidant for the halide X. When suitable nucleophilic acceptors are present, halo-genated compounds are formed. The presence of the haloperoxidases in organisms is believed to be related with the production of halogenated compounds with biocidal activity (S. A. Borchardt, et al., Appl. Environ. Microbial. 2001, Vol. 67, pages 3174 to 3179). Seawater contains about 1 mM of Br⁻ and 500 mM of Cl⁻, and as long as sufficient amounts of peroxide are present the antifouling paint will continuously generate HOX as a bactericidal agent. HOX has a strong antibacterial effect.

WO 95/27009 A1 suggests that the antimicrobial activities of vanadium chloroperoxidases may be used to prevent fouling of a marine paint surface by immobilizing the haloperoxidase in the paint surface and use halides and hydrogen peroxide present in sea water to provide antimicrobial reactions. Examples of this use include vanadium chlorohaloperoxidase mixed with a solvent-based chlorinated rubber antifouling product or immobilized in acrylic latex or a polyacrylamide matrix. The activity of a haloperoxidase in the conventional growth inhibiting agent (the chlorinated rubber antifouling product) is however very low due to the solvent of the anti-fouling agent and poor miscibility of the fouling agent with the haloperoxidase. Moreover, the enzymes are quite expensive to produce and unstable.

A limiting factor may be the concentration of hydrogen peroxide in seawater, which is present in concentrations ranging from 0.1 to 0.3 mM (R. G. Petasne, R. G. Zika, Mar. Chem. 1997, Vol. 56, Pages 15 to 25). Hydrogen peroxide is generated by photooxidation processes of water initiated by the UV light of the sun. Also as a result of biological activity peroxide may be generated resulting in higher peroxide levels. The idea to combat biofouling of surfaces by enzymes has its roots in the physiological role of the vanadium bromoperoxidase. In some seaweed the peroxidase is located extracellularly on the surface of the plant (R. Weyer, et al., Environ. Sci. Technol. 1991, Vol. 25, pages 446 to 449) and its possible role is to control colonization of surface seaweed by generating bactericidal HOBr. In addition, it was demonstrated that very low concentrations of HOBr inactivated bacterial homoserine lactones (S. A. Borchardt, et al., Appl. Environ. Microbial. 2001, Vol. 67, pages 3174 to 3179). These compounds play an important role in bacterial signaling systems. Interference with these systems inhibits bacterial biofilm formation, a first step in the fouling of surfaces. Similarly, it could be shown that some red macroalgae produced halogenated furanones that are encapsulated in gland cells in the seaweed, which provides a mechanism for the delivery of the metabolites to the surface of the algae at concentrations that deter a wide range of prokaryote and eukaryote fouling organisms (T. B. Rasmussen, et al., Microbiology 2000, Vol. 146, pages 3237 to 3244; S. Kjelleberg, P. Steinberg, Microbial. Today 2001, Vol. 28, pages 134 to 135).

U.S. Pat. No. 7,063,970 B1 describes the concept and advantages of using oxidoreductases for the preservation and/or conservation of water based paints as an alternative to conventional environmentally hazardous biocides. EP 500 387 A2 describes haloperoxidases for use in antiseptic pharmaceutical products.

V₂O₅ nanoparticles have been demonstrated to exhibit an intrinsic catalytic activity towards classical peroxidase substrates such as 2,2-Azino-bis(3-ethylbenzothiazoline-6-sulfonic acid) (ABTS) and 3,3,5,5,-tetramethylbenzdine (TMB) in the presence of H₂O₂. V₂O₅ nanoparticles showed an optimum reactivity at a pH of 4.0, and the catalytic activity was dependent on their concentration. The Michaelis-Menten kinetics of the ABTS oxidation reveals a behavior similar to their natural counterpart, vanadium-dependent haloperoxidase (V-HPO). The kinetic parameters indicate (i) a higher affinity of the substrates to the V₂O₅ nanowire surface and (ii) the formation of an intermediate metastable peroxo complex during the first catalytic step. The nanostructured vanadium-based material can be recycled and retains its catalytic activity in a wide range of organic solvents (up to 90%) (R. Andre, et al., Adv. Funct. Mater. 2011, Vol. 21, pages 501 to 509). Furthermore it was demonstrate that V₂O₅ nanoparticles exhibit haloperoxidase activity in the presence of hydrogen peroxide and a bromide source towards the bromination of 2-chlorodimedone, a classical haloperoxidase substrate (F. Natalia et al., Nature Nanotech. 2012, Vol. 7, pages 530 to 535). The reaction mechanism goes through the formation of HOBr species which are the active brominating species. It was further shown that V₂O₅ nano-particles could impart antimicrobial and antibiofouling properties when incorporated on surface coatings (EP 2 671 449 A1).

MoO₂ and MoO₃ have been shown to exhibit an antimicrobial effect (US 2010/0057199 A1).

CeO₂ nanoparticles have been shown to exhibit an intrinsic superoxide dismutase activity that protects biological tissues against radiation induced damage (J. Chen et al., Nature Nanotech. 2006, Vol. 1, pages 142 to 150).

Fe₃O₄ nanoparticles (L. Gao et al., Nature Nanotech. 2007, Vol. 2, pages 577 to 583) and (γ-Fe₂O₃) nanoparticles (K. N. Chaudhari et al., Catal. Sci. Technol. 2012, Vol. 2, pages 119 to 124) have been shown to exhibit an intrinsic peroxidase mimetic activity similar to that found in natural peroxidases which are used to oxidize organic substrates in the treatment of wastewater or as detection tools. Haloperoxidase activity has not been reported so far for iron oxides.

It was an object of the present invention to provide methods and uses to prevent biofouling of a substrate and to impart biocidal properties to the surface of a substrate that substantially avoid at least some of the problems of the quoted prior art. In particular, environmentally benign alternatives to the conventional biocides were sought which would additionally avoid the need for incorporating isolated enzymes in coating compositions.

Accordingly, it has been found that the above identified problems can be solved by the use of gamma iron(III) oxide (γ-Fe₂O₃) containing particles for the prevention of biofouling and/or growth of microorganisms, Said use can for example be accomplished by incorporating said particles into substrates like polymer and/or plastic coatings or optionally by rinsing the surfaces of said substrates (coatings) with rinsing suspensions containing these iron oxide containing particles. The present invention thus provides the substitution of conventional chemical biocides or costly and sensitive enzymatic systems as preservation systems.

One embodiment of the present invention is the use of gamma iron(III) oxide (γ-Fe₂O₃) containing particles for the prevention of biofouling and/or growth of microorganisms.

Another embodiment of the present invention is the use of gamma iron(III) oxide (γ-Fe₂O₃) containing particles for the prevention of biofouling and/or growth of microorganisms with a content of γ-Fe₂O₃ of at least 5 wt.-%, preferably at last 30 wt.-%, more preferably at least 90 wt.-%.

In a preferred embodiment of the present invention the γ-Fe₂O₃ containing particles have a particle size between 2 nm and 500 nm and/or a BET surface area between 3 and several hundred m²/g, preferably between 10 m²/g and 150 m²/g.

A preferred embodiment of the present invention is the use of gamma iron(III) oxide (γ-Fe₂O₃) containing particles with particle sizes up to 500 nm and/or a surface area up to 150 m²/g for the prevention of biofouling and/or growth of microorganisms. Particularly, the use of iron oxide particles according to the invention allows the prevention of growth of bacteria and/or organisms that cause biofouling, such as algae, diatoms and mussels.

As mentioned above, “biofouling” is usually caused by bacterial or algal growth with biofilm formation. Also barnacles, diatoms and mussels are notorious for attaching to and damaging man-made structures. The term “biofilm” shall mean, very generally, an aggregation of living and dead microorganisms, especially bacteria, that adhere to living and non-living surfaces, together with their metabolites in the form of extracellular polymeric substances (EPS matrix), e.g. polysaccharides. The activity of antimicrobial substances that normally exhibit a pronounced growth-inhibiting or lethal effect with respect to planktonic cells and other microorganisms may be greatly reduced with respect to microorganisms that are organized in biofilms, for example because of inadequate penetration of the active substance into the biological matrix.

In one embodiment of the present invention the use of gamma iron(III) oxide (γ-Fe₂O₃) containing particles is carried out in the presence of an oxidizing agent and a halide in order to facilitate the formation of a hypohalous acid. As mentioned above, hypohalous acids have a strong anti-microbial effect and are capable of penetrating biofilms on living and non-living surfaces, of preventing the adhesion of bacteria to surfaces and any further build-up of the biofilm, of detaching such biofilm and/or inhibiting the further growth of the biofilm-forming microorganisms in the biological matrix and/or of killing such microorganisms.

Very often an oxidizing agent and a halide are naturally present such as in seawater. Sometimes, however, these co-agents are absent or not present in sufficient quantities. In these cases the gamma iron(III) oxide (γ-Fe₂O₃) containing particles should be used together with an oxidizing agent and a halide selected from chloride, bromide and iodide. The oxidizing agent is preferably hydrogen peroxide or an organic peroxide. On the other hand, it is also possible to provide the oxidizing agent such as hydrogen peroxide through in-situ formation.

In the context of the invention the term “oxidizing agent” is to be viewed as a chemical or biological compound which may act as an electron acceptor and/or oxidant. The oxidizing agent may be mediated by a metal oxide catalyst as electron donor substrate, e.g. an enhancer. An “enhancer” is to be viewed as a chemical compound, which upon interaction with an oxidizing agent becomes oxidized or otherwise activated and which in its oxidize or otherwise activated state provides a more powerful antimicrobial effect than could be obtained by the oxidizing agent alone.

Another embodiment of the present invention is a method for preventing biofouling of a substrate, which method comprises adding gamma iron(III) oxide (γ-Fe₂O₃) containing particles as defined hereinabove to a matrix material and contacting said matrix material with the substrate or coating the substrate with said matrix material.

In the context of the invention the term “matrix material” shall mean coating binders, coating compositions containing binders, solvents and/or further coating additives, water or aqueous solutions.

Another embodiment of the present invention is a method of imparting biocidal properties to the surface of a substrate, which method comprises coating the surface with a composition comprising gamma iron(III) oxide (γ-Fe₂O₃) containing particles as defined hereinabove and a coating binder or a film forming binder.

Different embodiments can be envisaged herein. In one embodiment the gamma iron(III) oxide (γ-Fe₂O₃) containing particles are dispersed in a coating composition. This coating may be a polymer and/or plastic coating, i.e. the matrix forming the coating may be selected from coating binders, coating compositions containing binders, solvents and/or further coating additives. The coating composition comprising gamma iron(III) oxide (γ-Fe₂O₃) containing particles, once applied and optionally dried and/or cured, forms a surface with biocidal and/or antifouling properties. Examples of such coatings comprise paints including water based paints.

In the context of the invention the term “paint” is to be viewed as a coating composition usually comprising solid coloring matter dissolved or dispersed in a liquid dispersant, organic solvent and/or oils, which when spread over a surface, dries to leave a thin colored, decorative and/or protective film. In the context of the invention this term is however also viewed to encompass water based enamel, lacquer and/or polish compositions. A “Water based paint” is meant to comprise at least 10 percent water by weight.

Another embodiment of the present invention is a washing and cleaning formulation, e.g. household and general-purpose cleaners for cleaning and disinfecting hard surfaces, rinsing liquors and the like, containing the gamma iron(III) oxide (γ-Fe₂O₃) containing particles described above. In the latter embodiment the matrix material is meant to comprise water and/or aqueous solutions.

Furthermore, in the methods according to the invention the matrix material may be a coating binder or film forming binder, or the matrix material may be water or an aqueous solution or formulation selected from water processing fluids, aqueous cooling fluids, cleaning compositions or rinsing liquids.

Moreover, in the composition used in the methods of the invention gamma iron(III) oxide (γ-Fe₂O₃) containing particles may be comprised in an amount of 0.0001 to 25 percent by weight, preferably 0.001 to 5 percent by weight, relative to the weight of the matrix material.

The gamma iron(III) oxide (γ-Fe₂O₃) containing particles described above are useful in coatings or films in protecting surfaces from biofouling. Such surfaces include surfaces in contact with marine environments (including fresh water, brackish water and salt water environments), for example, the hulls of ships, surfaces of docks or the inside of pipes in circulating or pass-through water systems. Other surfaces are susceptible to similar biofouling, for example walls exposed to rain water, walls of showers, roofs, gutters, pool areas, saunas, floors and walls exposed to damp environs such as basements or garages and even the housing of tools and outdoor furniture.

The cleansing formulation, or the rinsing liquor as mentioned above, is an aqueous formulation containing besides the gamma iron(III) oxide (γ-Fe₂O₃) containing particles described above conventional components like surfactants, which may be non-ionic, anionic or zwitter-ionic compounds, sequestering agents, hydrotropes, alkali metal hydroxides (sources of alkalinity), preservative, fillers, dyes, perfumes and others. The components and their use in rinsing liquors are well known to those skilled in the art.

Some materials that can be used in connection with the present invention are exemplified herein below. The substrate can be a two-dimensional object such as a sheet or a film, or any three dimensional object; it can be transparent or opaque. The substrate can be made from any material, for example paper, cardboard, wood, leather, metal, textiles, nonwovens, glass, ceramics, stone and/or polymers.

Examples of metals are iron, nickel, palladium platinum, copper, silver, gold, zinc and aluminium and alloys such as steel, brass, bronze and duralumin.

Textiles can be made from natural fibres such as fibres from animal or plant origin, or from synthetic fibres. Examples of natural fibres from animal origin are wool and silk. Examples of natural fibres from plant origin are cotton, flax and jute. Examples of synthetic textiles are polyester, polyacrylamide, polyolefins such as polyethylene and polypropylene and polyamides such as nylon and lycra.

Examples of ceramics are products made primarily from clay, for example bricks, tiles and porcelain, as well as technical ceramics. Technical ceramics can be oxides such as aluminium oxide, zirconium dioxide, titanium oxide and barium titanate, carbides such as sodium, silicon or boron carbide, borides such as titanium boride, nitrides such as titanium or boron nitride and silicides such as sodium or titanium silicide.

Examples of stones are limestone, granite, gneiss, marble, slate and sandstone.

Examples of polymers are acrylic polymers, styrene polymers and hydrogenated products thereof, vinyl polymers and derivatives thereof, polyolefins and hydrogenated or epoxidized products thereof, aldehyde polymers, epoxide polymers, polyamides, polyesters, polyurethanes, polycarbonates, sulfone-based polymers and natural polymers and derivatives thereof.

When applied as a part of a film or coating, the gamma iron(III) oxide (γ-Fe₂O₃) containing particles described above are part of a composition which also comprises a binder.

The binder may be any polymer or oligomer compatible with the present gamma iron(III) oxide (γ-Fe₂O₃) containing particles. The binder may be in the form of a polymer or oligomer prior to preparation of the anti-fouling composition, or may form by polymerization during or after preparation, including after application to the substrate. In certain applications, such as certain coating applications, it will be desirable to crosslink the oligomer or polymer of the antifouling composition after application.

The term “binder” as used in the present invention also includes materials such as glycols, oils, waxes and surfactants commercially used in the care of wood, plastic, glass and other surfaces.

Examples include water proofing materials for wood, vinyl protectants, protective waxes and the like.

The composition may be a coating or a film. When the composition is a thermoplastic film which is applied to a surface, for example, by the use of an adhesive or by melt applications including calendaring and co-extrusion, the binder is the thermoplastic polymer matrix used to prepare the film.

When the composition is a coating, it may be applied as a liquid solution or suspension, a paste, gel, oil or the coating composition may be a solid, for example a powder coating which is subsequently cured by heat, UV light or other method.

As the composition may be a coating or a film, the binder can be comprised of any polymer used in coating formulations or film preparation. For example, the binder is a thermoset, thermoplastic, elastomeric, inherently crosslinked or crosslinked polymer.

Thermoset, thermoplastic, elastomeric, inherently crosslinked or crosslinked polymers include polyolefin, polyamide, polyurethane, polyacrylate, polyacrylamide, polycarbonate, polystyrene, polyvinyl acetates, polyvinyl alcohols, polyester, halogenated vinyl polymers such as PVC, natural and synthetic rubbers, alkyd resins, epoxy resins, unsaturated polyesters, unsaturated polyamides, polyimides, silicon containing and carbamate polymers, fluorinated polymers, cross-linkable acrylic resins derived from substituted acrylic esters, e.g. from epoxy acrylates, urethane acrylates or polyester acrylates. The polymers may also be blends and copolymers of the preceding chemistries.

Biocompatible coating polymers, such as poly[-alkoxyalkanoate-co-3-hydroxyalkenoate] (PHAE) polyesters (cf. Geiger et. al. Polymer Bulletin 2004, Vol. 52, pages 65 to 70), can also serve as binders in the present invention.

Alkyd resins, polyesters, polyurethanes, epoxy resins, silicone containing polymers, polyacrylates, polyacrylamides, fluorinated polymers and polymers of vinyl acetate, vinyl alcohol and vinyl amine are non-limiting examples of common coating binders useful in the present invention. Other coating binders, of course, are also part of the present invention.

Coatings are frequently crosslinked with, for example, melamine resins, urea resins, isocyanates, isocyanurates, polyisocyanates, epoxy resins, anhydrides, poly acids and amines, with or without accelerators.

In the methods of the present invention the composition for preventing biofouling of a substrate is for example a coating applied to a surface which is exposed to conditions favorable for bioaccumulation. The presence of the gamma iron(III) oxide (γ-Fe₂O₃) containing particles described above in said coating will prevent the adherence of organisms to the surface.

The gamma iron(III) oxide (γ-Fe₂O₃) containing particles of the present invention may be part of a complete coating or paint formulation, such as a marine gel-coat, shellac, varnish, lacquer or paint, or the antifouling composition may comprise only a polymer and binder, or a polymer. binder and a carrier substance. It is anticipated that other additives encountered in such coating formulations or applications will find optional use in the present applications as well. The coating may be solvent borne or aqueous. Aqueous coatings are typically considered more environmentally friendly.

The coating is, for example, an aqueous dispersion of a polymer and a binder or a water based coating or paint. For example, the coating comprises an aqueous dispersion of a polymer and an acrylic, methacrylic or acrylamide polymers or co-polymers or a poly[-alkoxyalkanoate-co-3-hydroxyalkenoate] polyester.

The coating may be applied to a surface which has already been coated, such as a protective coating, a clear coat or a protective wax applied over a previously coated article.

Coating systems include marine coatings, wood coatings, other coatings for metals and coatings over plastics and ceramics. Exemplary of marine coatings are gel-coats comprising an unsaturated polyester, a styrene polymer and a catalyst.

The coating is, for example, a house paint or other decorative or protective paint. It may be a paint or other coating that is applied to cement, concrete or other masonry article. The coating may be a water proofer as for a basement or foundation.

The coating composition is applied to a surface by any conventional means including spin coating, dip coating, spray coating, draw down, or by brush, roller or other applicator. A drying or curing period will typically be needed.

Coating or film thickness will vary depending on application and will become apparent to one skilled in the art after limited testing.

Besides the gamma iron(III) oxide (γ-Fe₂O₃) containing particles described above, the aqueous compositions or the coating compositions, may further comprise one or more antimicrobial or biocidal agents or auxiliary agents, for example pyrithiones, especially the sodium, copper and/or zinc complex (ZPT); Octopirox®; 1-(4-chlorophenyoxy)-1-(1-imidazolyl)3,3-dimethyl-2-butanone (Climbazol®), selensulfide; antifouling agents like Fenpropidin, Fenpropimorph, Medetomidine, Chlorothalonil, Dichlofluanid (N′-dimethyl-N-phenylsuphamide); 4,5-dichloro-2-n-octyl-3(2H)-isothiazolone (SeaNine™, Rohm and Haas Company); 2-methylthio-4-tert-butylamino-6-cyclopropylamino-striziane; Diuron (3-(3,4-dichlorophenyl)-1, 1-dimethylurea); Tolylfluanid (N-(Dichloroflouromethylthio)-N′,N′dimethyl-N-p-tolylsufamide); microparticles or nanoparticles of ZnO (e.g. <53 nm), TiO₂ (e.g. <40 nm), CuO (e.g. 33 nm -12 nm; isothiazolinones such as methylchloroisothiazolinone/methylisothiazolinone (Kathon CG®); methylisothiazolinone, methylchloroisothiazolinone, octylisothiazolinone, benzyl-isothiazolinone, methylbenzisothiazolinone, butylbenzisothiazolinone, dichlorooctyl-isothiazolinone; inorganic sulphites and hydrogen sulphites, sodium sulfite; sodium bisulfite; imidazolidinyl urea (Germall 115®), diazolidinyl urea (Germall 110); ethyl lau-royl arginate, farnesol, benzyl alcohol, phenoxyethanol, phenoxypropanol, biphenyl-2-ol, phenethyl alcohol, 2,4-dichlorobenzyl alcohol, chlorbutanol, 1,2-diols, 1,2-pentandiol, 1,2-hexandiol, 1,2-octandiol, 1,2-propandiol, 3(2-ethylhexyloxy)propane (ethylhexyl-glycerin), 1,3-diols, 2-ethyl-1,3-hexandiol, ethanol, 1-propanol, 2-propanol; 5-bromo-5-nitro-1,3-dioxane (Bronidox ®), 2-bromo-2-nitropropane-1,3-diol (Bronopol®); dibromhexamidin; formaldehyde, paraformaldehyde; iodopropynyl butylcarbamate (Polyphase P100®); chioroacetamide; methanamine; methyldibromonitrile glutaronitrile, (1,2dibromo-2,4-dicyanobutane or Tektamer®); glutaraldehyde; glyoxal; sodium hydroxymethylglycinate (Suttocide AC)); polymethoxy bicyclic oxazolidine (Nuosept CC)); dimethoxane; captan; chlorphenesin; dichlorophene; halogenated diphenyl ethers; 2,4,4′-trichloro-2′-hydroxy-diphenyl ether (Triclosan. or TCS); 4,4′-Dichloro-2-hydroxydiphenyl ether (Diclosan); 2,2′-dihydroxy-5,5′-dibromo-diphenyl ether; phenolic compounds; phenol; Para-chloro-meta-xylenol (PCMX); 2-Methyl Phenol; 3-Methyl Phenol; 4-Methyl Phenol; 4-Ethyl Phenol; 2,4-Dimethyl Phenol; 2,5-Dimethyl Phenol; 3,4-Dimethyl Phenol; 2,6-Dimethyl Phenol; 4-n-Propyl Phenol; 4-n-Butyl Phenol; 4-n-Amyl Phenol; 4-tert-Amyl Phenol; 4-n-Hexyl Phenol; 4-n-Heptyl Phenol; Mono- and Poly-Alkyl and Aromatic Halophenols; p-Chlorophenol; Methyl p-Chlorophenol; Ethyl p-Chlorophenol; n-Propyl p-Chlorophenol; n-Butyl p-Chlorophenol; n-Amyl p-Chlorophenol; sec-Amyl p-Chlorophenol; Cyclohexyl p-Chlorophenol; n-Heptyl p-Chlorophenol; n-Octyl p-Chlorophenol; o-Chlorophenol; Methyl o-Chlorophenol; Ethyl o-Chlorophenol; n-Propyl o-Chlorophenol; n-Butyl o-Chlorophenol; n-Amyl o-Chlorophenol; tert-Amyl o-Chlorophenol; n-Hexyl o-Chlorophenol; n-Heptyl o-Chlorophenol; o-Benzyl p-Chlorophenol; o-Benxyl-m-methyl p-Chlorophenol; o-Benzyl-m; m-dimethyl p-Chlorophenol; o-Phenylethyl p-Chlorophenol; o-Phenylethyl-m-methyl p-Chlorophenol; 3-Methyl p-Chlorophenol; 3,5-Dimethyl p-Chlorophenol; 6-Ethyl-3-methyl p-Chlorophenol; 6-n-Propyl-3-methyl p-Chlorophenol; 6-iso-Propyl-3-methyl p-Chlorophenol; 2-Ethyl-3,5-dimethyl p-Chlorophenol; 6-sec-Butyl-3-methyl p-Chlorophenol; 2-iso-Propyl-3,5-dimethyl p-Chlorophenol; 6-Diethylmethyl-3-methyl p-Chlorophenol; 6-iso-Propyl-2-ethyl-3-methyl p-Chlorophenol; 2-sec-Amyl-3,5-dimethyl p-Chlorophenol; 2-Diethylmethyl-3,5-dimethyl p-Chlorophenol; 6-sec-Octyl-3-methyl p-Chlorophenol; p-Chloro-m-cresol: p-Bromophenol; Methyl p-Bromophenol; Ethyl p-Bromophenol; n-Propyl p-Bromophenol; n-Butyl p-Bromophenol; n-Amyl p-Bromophenol; sec-Amyl p-Bromophenol; n-Hexyl p-Bromophenol; Cyclohexyl p-Bromophenol; o-Bromophenol; tert-Amyl o-Bromophenol; n-Hexyl o-Bromophenol; 25n-Propyl-m,m-Dimethyl o-Bromophenol; 2-Phenyl Phenol; 4-Chloro-2-methyl phenol; 4-Chloro-3-methyl phenol; 4-Chloro-3,5-dimethyl phenol; 2,4-Dichloro-3,5-dimethylphenol; 3,4,5,6-Terabromo-2-methylphenol; 5-Methyl-2-pentylphenol; 4-lsopropyl-3-methylphenol Para-chloro-meta-xylenol (PCMX); Chlorothymol; Phenoxyethanol; Phenoxyisopropanol; 5-Chloro-2-hydroxydiphenylmethane; Resorcinol and its Derivatives; Resorcinol; Methyl Resorcinol; Ethyl Resorcinol; n-Propyl Resorcinol; n-Butyl Resorcinol; n-Amyl Resorcinol; n-Hexyl Resorcinol; n-Heptyl Resorcinol; n-Octyl Resorcinol; n-Nonyl Resorcinol; Phenyl Resorcinol; Benzyl Resor cinol; Phenylethyl Resorcinol; Phenylpropyl Resorcinol; p-Chlorobenzyl Resorcinol; 5-Chloro 2,4-Dihydroxydiphenyl Methane; LV-Chloro 2,4-Dihydroxydiphenyl Methane; 5-Bromo 2,4-Dihydroxydiphenyl Methane; 4′-Bromo 2,4-Dihydroxydiphenyl Methane; bisphenolic compounds; 2,2′-methylene bis-(4-chlorophenol); 2,2′-methylene bis-(3,4,6-trichlorophenol); 2,2′-methylene bis-(4-chloro-6-bromophenol); bis(2-hydroxy-3,5-dichlorophenyl)sulfide; bis(2-hydroxy-5-chlorobenzyl)sulfide; halogenated carbanilides; 3,4,4′-trichlorocarbanilides (Triclocarban® or TCC); 3-trifluoromethyl-4,4′-dichlorocarbanilide; 3,3′,4-trichlorocarbanilide; chlorohexidine and its digluconate; diac-etate and dihydrochloride; hydroxybenzoic acid and its salts and esters (parabenes); methylparaben, ethylparaben, propylparaben, butylparaben, isopropylparaben, isobu-tylparaben, benzylparaben, sodium methylparaben, sodium propylparaben; benzoic acid and its salts, lactic acid and its salts, citric acid and its salts, formic acid and its salts, performic acid and its salts, propionic acid and its salts, salicylic acid and its salts, sorbic acids and its salts, 10-undecylenic acid and its salts; decanoic acid and its salts; dehydroacetic acid, acetic acid, peracetic acid, bromoacetic acid, nonanoic acid, lauric acid and its salts, glyceryl laurate, hydrochloric acid and its salts, sodium hypo-chlorite, hydrogen peroxide, sodium hydroxy methyl-aminoacetate, sodium hy-droxymethylglycinate, thiabendazole, hexetidine (1,3-bis(2-ethylhexyl)-hexahydro-5-methyl-5-pyrimidine); poly(hexamethylenebiguanide) hydrochloride (Cosmocil); hydroxy biphenyl and its salts such as ortho-phenylphenol; dibromo hexamidine and its salts including isethionate (4,4′-hexamethylenedioxy-bis(3-bromo-benzamidine) and 4,4′-hexamethylenedioxy-bis(3-bromo-benzamidinium 2-hydroxyethanesulfonate); mercury, (aceto-o)phenyl (i.e. phenyl mercuric acetate) and mercurate(2-),(orthoboate(3+o)phenyl, dihydrogene (i.e. phenyl mercuric borate); 4-chloro-3,5-dimethylphenol (Chloroxylenol); poly-(hexamethylene biguanide) hydrochloride; 2-benzyl-4-chlorphenol (Methenamine); 1-(3-chloroallyl)-3,5,7-triaza-1-azonia-adamantanchloride (Quaternium 15), 1,3-bis(hydroxymethyl)-5,5-dimethyl-2.4-imidazolidinedione (DMDM hydantoin, (Slydant®); 1,3-Dichloro-5,5-dimethylhydantoin; 1,2-dibromo-2,4-dicyano butane; 2,2′ methylene-bis(6-bromo-4-chloro phenol) bromo-chlorophene; 2-benzyl-4-chlorophenol (Chlorophenone); chloracetamide; 3-(4-chlorophenoxy)-1,2-propandiol(chlorophenesin); phenylmethoxymethanol and ((phenyl-methoxy)methoxy)-methanol (benzylhemiformal); N-alkyl(C12-C22)trimethyl ammoniumbromide and -chloride (cetrimonium bromide, cetrimonium chloride); dimethydidecylammonium chloride; benzyl-dimethyl-(4-(2-(4-(1,1,3,3-tetramethylbutyl)-phenoxy)-ethoxy)-ethyl)- ammonium chloride (benzethonium chloride); Alkyl-(C8-C18)-dimethyl-benzylammonium chloride, -bromide and saccharinate (benzalkonium chlo-ride, benzalkonium bromide, benzalkonium saccharinate); mercurate(1-ethyl)2-mercaptobenzoate(2-)-O,S-,hydrogene (Thiomersal or Thiomerosal); silver compounds such as organic silver salts, inorganic silver salts, silver chloride including formulations thereof such as JM Acticare® and micronized silver particles, organic silver complexes such as for example silver citrate (Tinosan SDC®) or inorganic silvers such as silver zeolites and silver glass compounds (e.g. Irgaguard® B5000, Irgaguard® B6000, Irgaguard® B7000) and others described in WO-A-99/18790, EP1041879B1, WO2008/128896; inorganic or organic complexes of metal such as Cu, Zn, Sn, Au etc.; geraniol, tosylchloramide sodium (Chloramin T); 3-(3,4-dichlorphenyl)-1,1-dimethylharnstoff (Diuron®); dichlofluanid; tolylfluanid; terbutryn;

cybutryne; (RS)-4-[1-(2.3-dimethylphenyl)ethyl]-3H-imidazole; 2-butanone peroxide; 4-(2-nitrobutyl)morpholine; N-(3-aminopropyl)-N-dodecylpropane-1,3-diamine (Diamin®); dithio-2,2′-bis(N-methylbenzamide); mecetroniumetilsulfat; 5-ethyl-1-aza-3,7-dioxabicyclo-(3,3,0)octan; 2,2-dibromo-2-cyanoacetamide; methylbenzimidazol-2-ylcarbamat (Carbendazim®); 1,2-dibromo-2,4-dicyanobutane; 4,4-Dimethyloxazolidine; tetrakis(hydroxymethyl)phosphonium sulfate; octenidine dihydrochloride; tebuconazole; glucoprotamine; Amines, n-C10-16- alkyltrimethylenedi-, reaction products with chloroacetic acid (Ampholyte 20®), PVP iodine; sodium iodinate, 1,3,5-Tris-(2-hydroxyethyl)-1,3,5-hexahydrotriazin; Dazomet.

Preferred additional antimicrobial agents for closed water systems are selected from the group consisting of dialdehydes; components containing an antimicrobial metal such as antimicrobial silver; formic acid, chlorine dioxide and components releasing formic acid or chlorine dioxide, and antimicrobial compounds of molecular weight 80 to about 400 g/mol.

Likewise of particular interest is the use of the gamma iron(III) oxide (γ-Fe₂O₃) containing particles described above as an ingredient in coating compositions or paints comprising as component (A) a film-forming binder for coatings and a metal oxide material as the component (B),

Multilayer systems are possible here as well, where the concentration of component (B) in the outer layer can be relatively high, for example from 1 to 15 parts by weight of (B), in particular 3 to 10 parts by weight of (B), per 100 parts by weight of solid binder (A).

The binder (component (A)) can in principle be any binder which is customary in industry, for example those described in Ullmann's Encyclopedia of Industrial Chemistry, 5th Edition, Vol. A18, pages 368 to 426, VCH, Weinheim 1991. In general, it is a film-forming binder based on a thermoplastic or thermosetting resin, predominantly on a thermosetting resin. Examples thereof are alkyd, acrylic, polyester, phenolic, melamine, epoxy and polyurethane resins and mixtures thereof.

Component (A) can be a cold-curable or hot-curable binder; the addition of a curing catalyst may be advantageous. Suitable catalysts which accelerate curing of the binder are described, for example, in Ullmann's Encyclopedia of Industrial Chemistry, Vol. A18, page 469, VCH Verlagsgesellschaft, Weinheim 1991.

Preference is given to coating compositions in which component (A) is a binder comprising a functional acrylate resin and a crosslinking agent.

Examples of coating compositions containing specific binders are:

1. paints based on cold- or hot-crosslinkable alkyd, acrylate, polyester, epoxy or melamine resins or mixtures of such resins, if desired with addition of a curing catalyst;

2. two-component polyurethane paints based on hydroxyl-containing acrylate, polyester or polyether resins and aliphatic or aromatic isocyanates, isocyanurates or polyisocyanates;

3. one-component polyurethane paints based on blocked isocyanates, isocyanurates or polyisocyanates which are deblocked during baking, if desired with addition of a melamine resin;

4. one-component polyurethane paints based on a trisalkoxycarbonyltriazine crosslinker and a hydroxyl group containing resin such as acrylate, polyester or polyether resins;

5. one-component polyurethane paints based on aliphatic or aromatic urethaneacrylates or polyurethaneacrylates having free amino groups within the urethane structure and melamine resins or polyether resins, if necessary with curing catalyst;

6. two-component paints based on (poly)ketimines and aliphatic or aromatic isocyanates, isocyanurates or polyisocyanates;

7. two-component paints based on (poly)ketimines and an unsaturated acrylate resin or a polyacetoacetate resin or a methacrylamidoglycolate methyl ester;

8. two-component paints based on carboxyl- or amino-containing polyacrylates and polyepoxides;

9. two-component paints based on acrylate resins containing anhydride groups and on a poly-hydroxy or polyamino component;

10. two-component paints based on acrylate-containing anhydrides and polyepoxides;

11. two-component paints based on (poly)oxazolines and acrylate resins containing anhydride groups, or unsaturated acrylate resins, or aliphatic or aromatic isocyanates, isocyanurates or polyisocyanates;

12. two-component paints based on unsaturated polyacrylates and polymalonates;

13. thermoplastic polyacrylate paints based on thermoplastic acrylate resins or externally cross-linking acrylate resins in combination with etherified melamine resins;

14. paint systems based on siloxane-modified or fluorine-modified acrylate resins;

15. paint systems , especially for clearcoats, based on malonate- blocked isocyanates with melamine resins (e.g. hexamethoxymethylmelamine) as crosslinker (acid catalyzed);

16. UV-curable systems based on oligomeric urethane acrylates, or oligomeric urethane acrylates in combination with other oligomers or monomers;

17. dual cure systems, which are cured first by heat and subsequently by UV or electron irradiation, or vice versa, and whose components contain ethylenic double bonds capable to react on irradiation with UV light in presence of a photoinitiator or with an electron beam.

In addition to components (A) and (B), the coating composition preferably comprises as component (C) a light stabilizer of the sterically hindered amine type, the 2-(2-hydroxyphenyl)-1,3,5-triazine and/or 2-hydroxyphenyl-2H-benzotriazole type. Further examples for light stabilizers of the 2-(2-hydroxyphenyl)-1,3,5-triazine type advantageously to be added can be found e.g. in the publications US-A-4619956, EP-A-434608, U.S. Pat. No. 5,198,498, U.S. Pat. No. 5,322,868, U.S. Pat. No. 5,369,140, U.S. Pat. No. 5,298,067, WO-94/18278, EP-A-704437, GB-A-2297091, WO-96/28431. Of special technical interest is the addition of the 2-(2-hydroxyphenyl)-1,3,5-triazines and/or 2-hydroxyphenyl-2H-benzotriazoles, especially the 2-(2-hydroxyphenyI)-1,3,5-triazines.

To achieve maximum light stability, it is of particular interest to add sterically hindered amines. The invention therefore also relates to a coating composition which in addition to components (A) and (B) comprises as component (C) a light stabilizer of the sterically hindered amine type.

This stabilizer is preferably a 2,2,6,6-tetraalkylpiperidine derivative containing at least one group of the formula

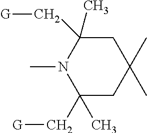

in which G is hydrogen or methyl, especially hydrogen. Examples of tetraalkylpiperidine derivatives which can be used as component (C) are given in EP-A-356 677, pages 3 to 17, sections

Apart from components (A), (B) and, if used, (C), the coating composition can also comprise further components, examples being solvents, pigments, dyes, plasticizers, stabilizers, thixo-tropic agents, drying catalysts and/or levelling agents. Examples of possible components are those described in Ullmann's Encyclopedia of Industrial Chemistry, 5th Edition, Vol. A18, pages 429 to 471, VCH, Weinheim 1991.

Possible drying catalysts or curing catalysts are, for example, organometallic compounds, amines, amino-containing resins and/or phosphines. Examples of organometallic compounds are metal carboxylates, especially those of the metals Pb, Mn, Co, Zn, Zr or Cu, or metal chelates, especially those of the metals Al, Ti or Zr, or organometallic compounds such as organotin compounds, for example,

Examples of metal carboxylates are the stearates of Pb, Mn or Zn, the octoates of Co, Zn or Cu, the naphthenates of Mn and Co or the corresponding linoleates, resinates or tallates.

Examples of metal chelates are the aluminium, titanium or zirconium chelates of acetylacetone, ethyl acetylacetate, salicylaldehyde, salicylaldoxime, o-hydroxyacetophenone or ethyl trifluoroacetylacetate, and the alkoxides of these metals.

Examples of organotin compounds are dibutyltin oxide, dibutyltin dilaurate or dibutyltin dioctoate.

Examples of amines are, in particular, tertiary amines, for example tributylamine, triethanolamine, N-methyldiethanolamine, N-dimethylethanolamine, N-ethylmorpholine, N-methylmorpholine or diazabicyclooctane (triethylenediamine) and salts thereof. Further examples are quaternary ammonium salts, for example trimethylbenzylammonium chloride.

Amino-containing resins are simultaneously binder and curing catalyst. Examples thereof are amino-containing acrylate copolymers.

The curing catalyst used can also be a phosphine, for example triphenylphosphine.

The coating compositions can also be radiation-curable coating compositions. In this case, the binder essentially comprises monomeric or oligomeric compounds containing ethylenically unsaturated bonds, which after application are cured by actinic radiation, i.e. converted into a crosslinked, high molecular weight form. Where the system is UV-curing, it generally contains a photoinitiator as well. Corresponding systems are described in the abovementioned publication Ullmann's Encyclopedia of Industrial Chemistry, 5th Edition, Vol. A18, pages 451 to 453. In radiation-curable coating compositions, the novel stabilizers can also be employed without the addition of sterically hindered amines.

Depending on the binder system, the coatings can be cured at room temperature or by heating. The coatings are preferably cured at 50 to 150° C., and in the case of powder coatings or coil coatings even at higher temperatures.

### EXAMPLES

### Sample Composition The different phase compositions and characteristics of Fe₂O₃ and other particles tested are listed in Table 1.

TABLE 1
Composition and characteristics of particles tested.

| | | | | Primary | | |
|---|---|---|---|---|---|---|
| | | | | particle | | Crystallite |
| | | | | size | | size (nm, |
| Example | Composition | Provider | BET (m²/g) | (TEM) | | XRD) |
| 1 | α-Fe₂O₃ | BASF SE | 127 | 100 | nm | 10.5 |
| | | (Sicotrans ® | | | | |
| | | Rot L2818) | | | | |
| 2 | α-Fe₂O₃ | ThyssenKrupp | 3.7 | 500 nm- | | 119 |
| | | AG (HP) | | 1 μm | | |
| 3 | α/γ-Fe₂O₃ | BASF SE | 78 | 50-100 | nm | Hematit: 31 |
| | (59 wt % | (Sicotrans ® | | | | Maghemit: 4 |
| | maghemite, 41 wt | Rot L2715D) | | | | |
| | % hematite) | | | | | |
| 4 | γ-Fe₂O₃ | Sigma-Aldrich | 32 | 10-100 | nm | 39 |
| | | (Kat. Nr. | | | | |
| | | 544884) | | | | |
| 5 | MoO₃ supported | synthesized | 27 | 100-500 | nm | not determined |
| | on SiO₂ (4.6 wt | | | | | |
| | % Mo) | | | | | |
| 6 | Mg₆Al₂(OH)₁₈ × | synthesized | not determined | 500 | nm | not determined |
| | 4.5 H₂O doped | | | | | |
| | with 2 wt % Mo | | | | | |

Catalytic activity for oxidative halogenation

In general the bromination activity of the Fe₂O₃ and other particles according to Examples 1 to 6 was determined spectrophotometrically using the classical 2-chlorodimedone (MCD) assay as previously described for V-HPO [Hager et al., J. Biol. Chem. 1966, Vol. 241, pages 1969 to 1977] and for inorganic materials like V₂O₅ [F. Natalio et al., Nature Nanotech. 2012, Vol. 7, pages 530 to 535 and EP 2 671 449 A1], i.e. by measuring initial rates of 2-chlorodimedone consumption at 290 nm (ε 290nm=19.9 mM⁻¹ cm⁻¹) on a Cary 300 UV-Vis spectrophotometer (Varian Inc., Palo Alto, Calif., USA). Bromination activity was measured in artificial seawater (ASTM D1141) varying the concentration of the particles (20 to 50 μg/ml) and keeping constant the concentrations of MCD (5 μM) (Cat. No. H12035, Alfa Aeser, Germany), KBr (1 mM) (Cat. No. P0838BioXtra, ≧99.0%, Sigma-Aldrich) and H₂O₂ (10 μM) (Cat. No. 8070.1, ROTIPURAN® p.a., ISO, stabilized, Carl Roth GmbH & Co.KG Karlsruhe, Germany) during 180 s at 25±2° C. The pH was maintained at 8.3 with a Tris-SO₄ buffer. Prior to the experiments, H₂O₂ concentration was calculated by measuring the absorbance of the solution at 240 nm and molar extinction coefficient of 43.6 M⁻¹ cm⁻¹. The average values of the initial bromination rates presented are a statistical average of three measurements.

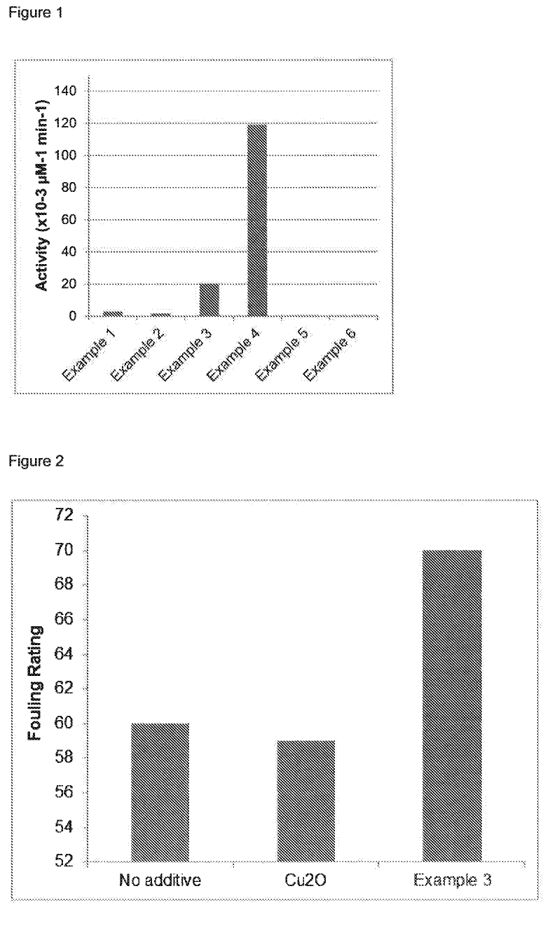

The bromination activity, i.e. the MCD consumption rates, of Fe₂O₃ and other particles according to Examples 1 to 6 can be seen in FIG. 1. The decay of the MCD concentration was indicative of an intrinsic brominating activity of the particles through the formation of HOBr species.

FIG. 1: MCD Bromination activity of the different particles according to Examples 1 to 6. Reaction was carried out in artificial sea water (ASTM D1141) with 1 mM KBr, 10 μM H₂O₂ and 40 μg/mL of catalyst.

Paint compositions preserved by γ-Fe₂O₃ containing particles

The antibacterial/antifouling activity of particles according to Examples 1 to 6 against bacteria (E. coli) was evaluated under pH conditions similar to sea water (pH 8.1).

The particles were mixed into a commercially available boat paint (silicone alkyd based paint, white color, Toplac®, International Farbenwerke GmbH, Boernsen, Germany) in a concentration of 0.5 wt.-% which was applied to 2×2 cm stainless steel plates. As a control plates were painted with the same paint formulation with no added particles. The samples where submersed in 15 ml E. coli (in LB medium) cell cultures supplemented with Br⁻ (1 mM) and H₂O₂ (10 μM). Each steel plate was exposed to this mixture for 3 days at 37° C. Addition of H₂O₂ and Br⁻ fresh solutions was done every 12 h. After the incubation time the substrates were gently washed with LB media and PBS buffer. Bacterial cells were stained with 4,6-diamino-2-phenylindole (DAPI, 1 mg/mL, a nuclear stain) and fluorescence analysis was performed using an Olympus AHBT3 light microscope, together with an AH3-RFC reflected light fluorescence attachment. The presence of bacterial colonies is easily detected by the presence of bright blue “dots” or “clusters”. Colony counting was performed by integration with digital image software ImageJ. Table 2 shows the antibacterial activity of the different particles (reduction in bacterial adhesion on the coated surfaces). Control paints with no added particles are considered to have a 0% reduction in bacterial colony adhesion. The particles are considered active in the reduction of biofilm formation when a reduction in bacterial adhesion of more than 50% is observed.

The γ-Fe₂O₃ containing materials can effectively avoid the formation of biofouling by avoiding the adhesion of bacterial biofilms.

TABLE 2
Reduction on E. coli bacterial colony attachment to paint surfaces
using formulations with 0.5 wt.-% of particles according to Examples
1 to 6, in comparison with paint surface with no particles added.

| | Reduction in bacterial colony adhesion |
|---|---|
| Example | (%)* |
| 1 | 5 |
| 2 | 5 |
| 3 | 80 |
| 4 | 80 |
| 5 | 0 |
| 6 | 0 |

*Values are approximate, due to the evaluation method used

In situ antifouling activity was evaluated for Example 3 formulated into a commercially available boat paint (silicone alkyd based paint, white color, Type Toplace, International Farbenwerke GmbH, Boernsen, Germany) in a concentration of 2 wt.-% in the North Sea at Norderney, Germany using the ASTM method D3623-78a and inspections were done using the ASTM method D6990-03. In FIG. 2 the Fouling Rating for control samples (no additive and 10 wt. % Cu₂O, respectively) and Example 3 are summarized. The sum of surface coverage by fouling is expressend by “Fouling Rating” (FR). The best value for a surface with no fouling is 100. Every percentage of coverage by fouling is subtracted from this number. A high FR indicates a better antifouling performance.

As shown in FIG. 2 the γ-Fe₂O₃ containing material (Example 3) features a better performance than samples with no additive or even with 10 wt. % Cu₂O in a non-polishing formulation.

FIG. 2. Antifouling performance for Example 3 compared to control samples (no additive or 10 wt. % Cu20). Tests were performed in Norderney. Germany for a period of 21 days.

1-5. (canceled)

6. Method for limiting biofouling of a substrate, the method comprising adding particles that include gamma iron(III) oxide (γ-Fe₂O₃) to a matrix material, and contacting or coating the substrate with the matrix material.

7. Method according to claim 6, wherein the matrix material comprises a coating binder on film forming binder.

8. Method according to claim 7, wherein the matrix material further comprises one or more agents selected from antimicrobial agent, biocidal agent, or auxiliary agent.

9. An aqueous formulation comprising particles that include 30 wt.-% gamma iron(III) oxide (γ-Fe₂O₃), wherein the particles have a particle size between 2 and 500 nm, and a BET surface area between 10 and 150 m²/g.

10. Method according to claim 6, wherein the γ-Fe₂O₃ is present in the particles in an amount of at least 30 wt.-%.

11. Method according to claim 6, wherein the particles have a particle size between 2 and 500 nm.

12. Method according to claim 6, wherein the particles have a BET surface area between 10 and 150 m²/g.

13. Method according to claim 11, wherein the particles have a BET surface area between 10 and 150 m²/g.

14. Method according to claim 6, wherein the matrix material further comprises an oxidizing agent, and a halide selected from chloride, bromide and iodide.

15. Method according to claim 14, wherein the oxidizing agent is hydrogen peroxide.

16. Method according to claim 6, wherein the particles are present in the matrix material in an amount of 0.001 to 5 percent by weight, relative to the weight of the matrix material.

17. The formulation according to claim 9, further comprising a coating binder or film forming binder.
